(19) United States
(12) Patent Application Publication
(10) Pub. No.: US 2026/0139727 A1
(43) Pub. Date: May 21, 2026

(54) SLIP HOOK FOR CHAIN

(71) Applicant: Leonard W. Angelastro, North Franklin, CT (US)

(72) Inventor: Leonard W. Angelastro, North Franklin, CT (US)

(21) Appl. No.: 19/389,956

(22) Filed: Nov. 14, 2025

Related U.S. Application Data
(60) Provisional application No. 63/722,031, filed on Nov. 18, 2024.

(51) Int. Cl. F16G 17/00

(52) U.S. Cl. CPC F16G 17/00

(57) ABSTRACT

A slip hook for use with a chain is disclosed. The slip hook may include a tube having an opening through a longitudinal length of the tube for receiving a chain. The slip hook includes a hook attached to the tube exterior surface. The hook configured to engage with a chain proximal end to form a chain loop for securing an object to be towed, pulled, or lifted via force applied to a distal end of the chain.

### CROSS-REFERENCE TO RELATED APPLICATION

This application claims priority from U.S. Provisional Ser. No. 63/722,031 filed Nov. 18, 2024, the entire disclosure of which is incorporated herein by reference.

### TECHNICAL FIELD

The present disclosure relates to a slip hook for chain.

### BACKGROUND

It is known that moving large objects or removing items stuck in ground or other surfaces is challenging. For example, removing and lifting trees, tree stumps, fence posts, and other poles, has been a persistent challenge for many years. This problem is not limited to just homeowners; it significantly impacts farmers, ranchers, and other professional services, including arborists, orchardists, foresters, tree surgeons and landscapers. The presence of stumps may create difficulty in cultivating new plants or trees in the area. There exist different mechanisms/devices to remove the trees, tree stumps, fence and other embedded posts and poles. For instance, bulldozers or heavy equipment are often used for removing the trees, tree stumps, posts and poles. However, the existing mechanisms/devices are costly and may remove the tree stump without removing the roots.

Similarly, in the logging industry or the farming industry, dragging/towing of logs (or other objects) has been a persistent challenge. For instance, when logs are cut down, the logs often need to be moved from the forest to the processing sites. There exist different mechanisms/devices for the transportation of logs. However, the existing mechanisms/devices may not be effective in performing the dragging/towing operation.

In light of the above, a device is needed that facilities in removal of stuck items (e.g., from the ground) and/or dragging/towing and lifting operations, and may be easy to use and economical to manufacture.

It is with respect to these and other considerations that the disclosure made herein is presented.

### SUMMARY OF THE INVENTION

In one embodiment the disclosure includes a device having a tube defining first and second opposing ends, a hook is attached to an exterior surface of the tube near the first end thereof, an opening of the hook facing the second end of the tube, the tube being configured to receive a chain through an interior thereof, and the hook positioned to engage a proximal end of a chain. In one embodiment, the opening in the hook is configured to engage a link of the chain for securing the chain to the hook. In one embodiment, the hook is a grab hook configured to receive a link of a chain.

In one embodiment, the tube has a length approximately three times a length of the hook. In other embodiments, the length of the hook is between about ten to fifty percent relative to a length of the tube.

The device being operable with a chain extending through the tube and secured to the hook at a proximal end and form a loop between the hook and the first end of the tube, the loop configured to encircle an object to be pulled or dragged via a pulling implement attached to a distal end of the chain.

In one embodiment, the device includes a length of the hook being aligned with a longitudinal opening defined by the tube. The closed end of the hook may be substantially aligned with the first end of the tube. In one embodiment the device an inside diameter of the tube is sized to correspond to a size of the opening in the hook for use with a chain sized for use with the tube and hook such that the chain fits through the opening in the tube and the opening in the hook is sized to receive a link of the chain so the link of the chain is retained by the hook when a pulling force is applied to the chain through the tube.

a first leg of the hook is attached along a length of the exterior surface of the tube.

In a preferred embodiment a first leg of the hook is attached along a length of the exterior surface of the tube via welding.

In one embodiment, the hook defines a gap between first and second opposing legs of the hook, the gap configured to receive a link of the chain for securing the chain to the hook when a force is applied to the chain. In one embodiment, the second leg of the hook is longer than the first leg of the hook. The second leg of the hook may be fixed to the exterior surface of the tube.

In another embodiment, the disclosure provides slip hook for use with a chain including a tube having first and second opposing ends, a grab hook attached to an exterior surface of the tube near the first end thereof, the grab hook defining an opening configured to receive a link of a chain and secure the chain to the hook when a force is applied to an opposing end of the chain, the opening in the grab hook facing a second end of the tube, wherein the slip hook is configured to secure a chain to an object for pulling or dragging the object.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example device and a chain in a first position, in accordance with the present disclosure.

FIG. 2 depicts an example device and a chain in a second position, in accordance with the present disclosure.

FIG. 3 depicts a first example environment in which techniques and structures for providing the systems and methods disclosed herein may be implemented.

FIG. 4 depicts a second example environment in which techniques and structures for providing the systems and methods disclosed herein may be implemented.

### DETAILED DESCRIPTION

The disclosure will be described more fully hereinafter with reference to the accompanying drawings, in which example embodiments of the disclosure are shown, and not intended to be limiting.

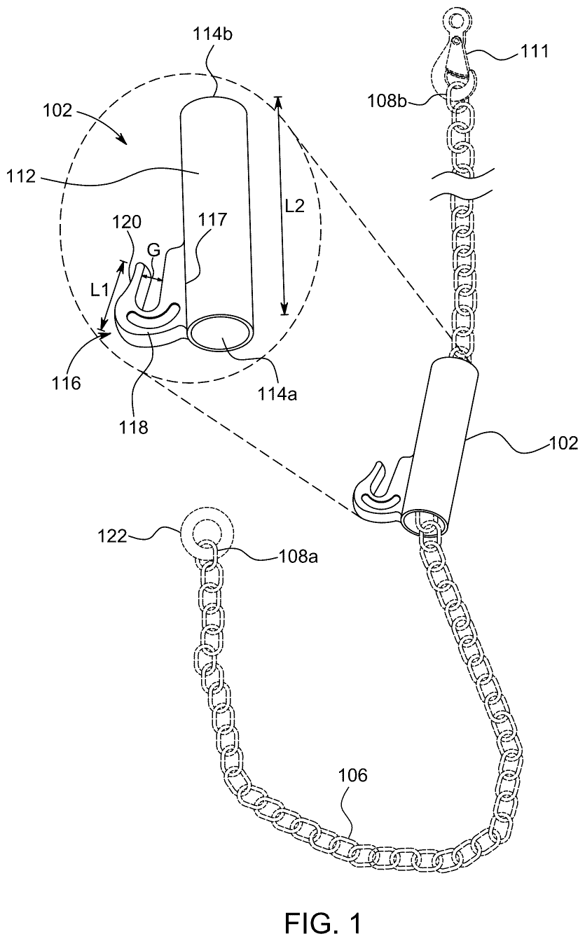

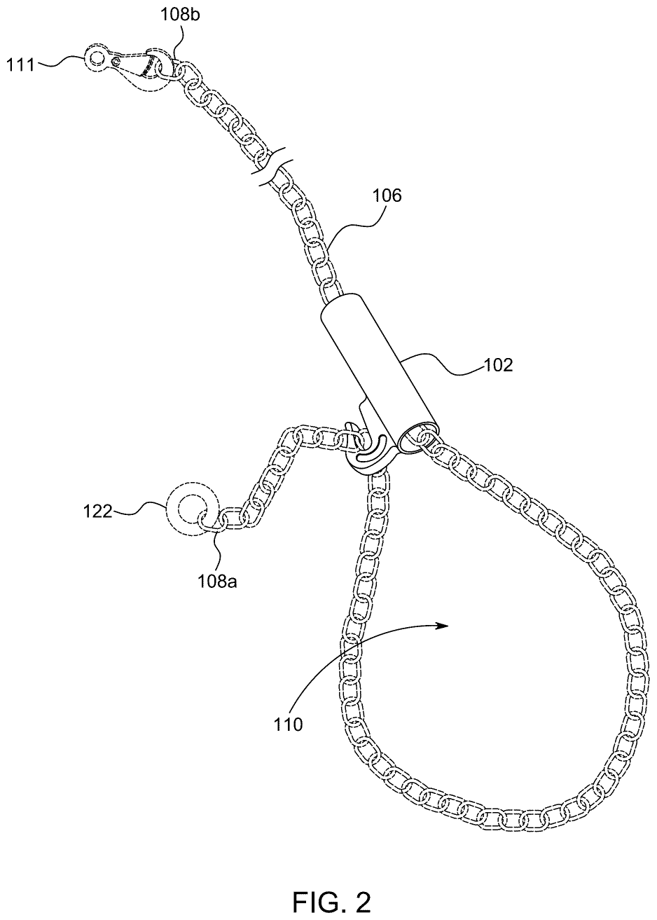

FIG. 1 depicts an one embodiment of a slip hook or device 102 as used with a chain 106 in a first position, in accordance with the present disclosure. FIG. 1 will be described in conjunction with FIG. 2.

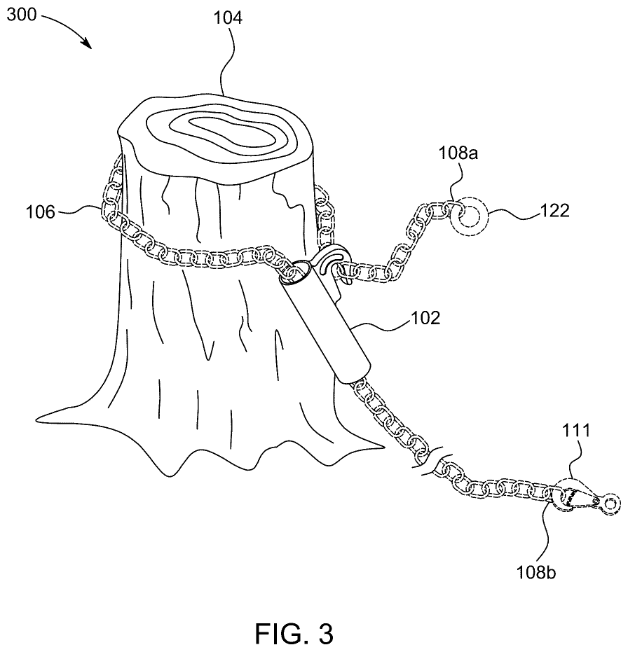

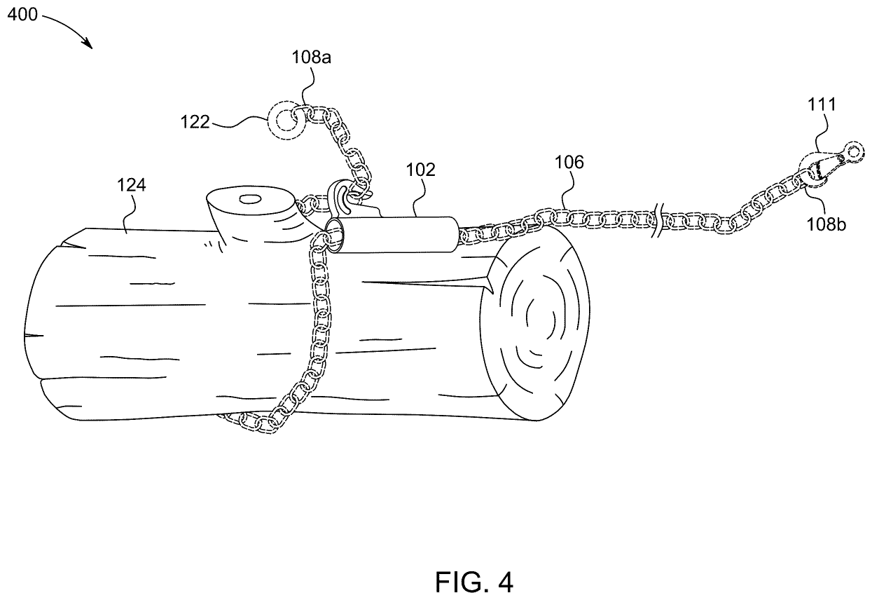

The device 102 may be a slip hook that may be used in different industries to perform different operations including, but not limited to, removal of a tree stump 104 (or a tree) from ground (as shown in FIG. 3), dragging/towing of a log 124 or any other object/tool (as shown in FIG. 4), and/or the like. The chain 106 shown as used with the device 102 may include a chain proximal end 108a and a chain distal end 108b. The chain proximal end 108a may wrap around an object (e.g., the tree stump 104, the log 124, etc.) to form a chain loop 110 (as shown in FIG. 2). The chain distal end 108b may be connected to a machine (e.g., an external machine, not shown), via a connector 111, which may apply a pulling force to the chain 106 to move the object (e.g. log 124). In some aspects, the external machine may be a small vehicle such as a ride on lawn mower, tractor, etc. In another aspect, the external device may be a winch (e.g., a hand winch).

The device 102 may be a rigid structure that may be made of any material. In an exemplary aspect, the device 102 may be made of steel, aluminum, fiberglass, etc. and/or the like. The device 102 may be made of any suitable material and have any dimensions (height, width, thickness) depending on the intended use. In some aspects, the device 102 may include an elongated hollow tube 112 (e.g., hollow tube 112). The hollow tube 112 may be of any shape such as cylindrical, cuboidal, etc. The chain 106 as shown in the Figures is a typical chain configured to pass through the hollow tube 112. As will be obvious to one skilled in the art, the chain 106 could be replaced with a cable or strap and is not part of the claimed subject matter.

The hollow tube 112 defines an interior surface and an exterior surface (not numbered in the Figures). The interior surface may be a surface that faces the chain 106 when the chain 106 passes through the hollow tube 112. The exterior surface may be opposite to the interior surface. The hollow tube 112 may include a tube proximal end 114a and a tube distal end 114b. The tube proximal end 114a defines a hook 116 that may be configured to secure the chain proximal end 108a, which enables formation of the chain loop 110 that wraps around the object 124 securing the chain to the object 124 when a pulling force is applied to the distal end 108b of the chain 106.t. The hook 116 may be located at the tube exterior surface. The hook 116 includes a rear side 117 attached to the exterior surface of the tube 112 via a connection mechanism such as welding, adhesive, etc. so that the opening “G” of the hook is spaced apart from the tube 112. The hook 116 may be of any shape including, but not limited to, U-shape or L-shape. The hook 116 is attached to the tube 112 so that the hook opening “G” opens in a direction opposite the proximal end 114a of the tube so as to secure the proximal end 108a of the chain 106 in a direction opposite the pulling force applied to the distal end 108b of the chain 106. In the illustrated embodiment the hook 116 is shown as a grab hook or chain hook configured to receive a link of the chain 106 attached near at or near the proximal end 114a of the tube 112. The hook 116 may have a first length “L1”. In some aspects, the first length “L1” may be less than a second length “L2” of the hollow tube 112. In an exemplary aspect, the first length “L1” may be in range of 10-50% of the second length “L2”.

In some aspects, the hook 116 may include a horizontal portion 118 and a vertical portion 120. A horizonal portion longitudinal axis may be perpendicular to a tube longitudinal axis. A vertical portion longitudinal axis may be parallel to the tube longitudinal axis. The horizontal portion 118 may include a horizontal proximal end and a horizontal distal end. The horizontal proximal end may contact the tube exterior surface, and the horizontal distal end may contact a vertical portion bottom end. A gap “G” exists between the vertical portion 120 and the hollow tube 112 (e.g., the exterior surface of the hollow tube 112). The gap “G” may be configured to receive the chain proximal end 108a to secure the chain proximal end 108a and form the chain loop 110. In some aspects, the chain proximal end 108a may include a stopper 122 that may secure (lock) the chain proximal end 108a within the gap “G” and prevent the chain 106 from escaping out from the hook 116 during the tree stump removal process. The stopper 122 may have any structure that may lock the chain proximal end 108a within the gap “G”. In some aspects, the stopper 122 may have an O-ring or any other structure. In some aspects, a size (width) of the stopper 122 may be larger than the gap “G” that facilitates locking of the chain proximal end 108a within the gap “G”.

FIG. 3 depicts a first example environment 300 in which techniques and structures for providing the systems and methods disclosed herein may be implemented. The environment 300 includes the tree stump 104 and the device 102 that may facilitate removal of the tree stump 104 (or a tree) from ground. The device 102 may engage with the chain 106 (or a cable/wire), to remove the tree stump 104. The chain 106 may be configured to engage with the tree stump 104 to remove the tree stump 104. The chain proximal end 108a may wrap around the tree stump 104 to form the chain loop 110, and the chain distal end 108b may be connected to the other device, via the connector 111, which may pull the chain 106 to remove the tree stump 104 from the ground. In some aspects, the external device may be a small vehicle such as a riding on lawn mower, tractor, etc. In another aspect, the external device may be a winch (e.g., a hand winch).

In operation, to remove the tree stump 104 from the ground, a user (not shown) may pass the chain 106 through the hollow tube 112, and wrap the chain proximal end 108a around the tree stump 104. Thereafter, the user may engage the chain proximal end 108a with the hook 116. Stated another way, the user may insert the chain proximal end 108a in the gap “G” to form the chain loop 110. The user may then attach the chain distal end 108b to the external device, and then pull the tree stump 104 via the external device.

After removal of the tree stump 104, the user may take out the chain proximal end 108a from the hook 116. Stated another way, the user may slide the chain proximal end 108a from the gap “G”. The user may then take the chain 106 out from the hollow tube 112.

In this manner, the device 102 facilitates removal of tree stumps (or tree) from the ground. The device 102 is easy to use and economical to manufacture. In addition, the device 102 is lightweight, portable, and may be used to remove tree stumps of any size.

FIG. 4 depicts a second example environment 400 in which techniques and structures for providing the systems and methods disclosed herein may be implemented. In addition to the removal of tree stump 104, the device 102 may be used in the logging or farming industry for attaching the chain 106 to various objects for towing or other purposes, without departing from the scope of the present disclosure. For instance, the device 102 may facilitate in towing/dragging of the log 124 from a first location to a second location or in transportation of the log 124 (or other objects).

The environment 400 includes the log 124 and the device 102. The user may attach the chain 106 to the log 124 by using the device 102 in the similar manner as described above. Once the chain 106 is attached to the log 124 via the device 102, the user may easily tow or haul heavy logs using machinery such as tractors, skidders, or logging trucks, enhancing efficiency and productivity.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A device comprising:
a tube having first and second opposing ends,
a hook attached to an exterior surface of the tube near the first end thereof,
an opening of the hook facing the second end of the tube,
the tube being configured to receive a chain through an interior thereof, and
the hook positioned to engage a proximal end of a chain.

2. The device of claim 1 wherein the opening in the hook is configured to engage a link of the chain for securing the chain to the hook.

3. The device of claim 1 wherein the hook is a grab hook.

4. The device of claim 1 wherein the tube has a length approximately three times a length of the hook.

5. The device of claim 1 wherein a length of the hook is between about ten to fifty percent relative to a length of the tube.

6. The device of claim 1 wherein a chain extending through the tube can be secured to the hook at a proximal end and form a loop between the hook and the first end of the tube, the loop configured to encircle an object to be pulled or dragged via a pulling implement attached to a distal end of the chain.

7. The device of claim 1 wherein a length of the hook is aligned with a longitudinal opening defined by the tube.

8. The device of claim 1 wherein a closed end of the hook is substantially aligned with the first end of the tube.

9. The device of claim 1 wherein an inside diameter of the tube is sized to correspond to a size of the opening in the hook for use with a chain sized in accordance with the tube and hook.

10. The device of claim 1 wherein a first leg of the hook is attached along a length of the exterior surface of the tube.

11. The device of claim 1 wherein the hook is welded to the exterior surface of the tube.

12. The device of claim 1 wherein the hook defines a gap between first and second opposing legs of the hook, the gap configured to receive a link of the chain for securing the chain to the hook when a force is applied to the chain.

13. The device of claim 12 wherein the second leg of the hook is longer than the first leg of the hook.

14. The device of claim 12 wherein the second leg of the hook is fixed to the exterior surface of the tube.

15. The device of claim 1 wherein the tube is arranged so that a pulling force applied to a distal end of the chain moves the chain through the tube for tightening a loop formed in the chain around an object to be pulled or dragged by the pulling force, the device configured for securing the object to the chain.

16. A slip hook for use with a chain comprising:
a tube having first and second opposing ends,
a grab hook attached to an exterior surface of the tube near the first end thereof, the grab hook defining an opening configured to receive a link of a chain and secure the chain to the hook when a force is applied to an opposing end of the chain,
the opening in the grab hook facing a second end of the tube,
the slip hook for use to secure a chain to an object for pulling or dragging the object.
